(19) United States
(12) Patent Application Publication
(10) Pub. No.: US 2003/0090697 A1
(43) Pub. Date: May 15, 2003

(54) Printer that redirects jobs to buddy printer

(75) Inventors: Samuel M. Lester, Boise, ID (US); Jimmy Sfaelos, Eagle, ID (US)

Correspondence Address: FOLEY AND LARDNER, SUITE 500, 3000 K STREET NW, WASHINGTON, DC, 20007, US

(73) Assignee: HEWLETT-PACKARD CO.

(21) Appl. No.: 09/986,608

(22) Filed: Nov. 9, 2001

(51) Int. Cl. B41J 1/00; G06F 15/00; B41F 1/00

(52) U.S. Cl. 358/1.14; 358/1.1

(57) ABSTRACT

A network printer is assigned a buddy printer, whereby when the network printer is in a Not Ready to process new print jobs state, any print jobs received by the network printer are redirected to the buddy printer for execution. The current status of the buddy printer is determined by the network printer, whereby print jobs are redirected to the buddy printer only when the buddy printer is currently in the Ready state.

### BACKGROUND OF THE INVENTION

1. Field of the Invention

The present invention relates to network printers, and in particular to a network printer that redirects a print job to another printer, called a buddy printer, to handle a print job that the network printer cannot handle for some reason. This redirection may be due to the network printer being in a not ready state whereby it is experiencing a recoverable error or a non-recoverable error that makes it incapable of finishing the print job that it has started, and results in an increased reliability of the network printing system.

2. Description of the Related Art

Many companies have computer networks in which several computers are capable of communicating with each other and with other devices on the network. For example, many companies have electronic mail systems, or e-mail, in which employees can send electronic messages to one another via their computers. The e-mail travels from a sending computer to a receiving computer via a computer network, such as the Internet, whereby the e-mail is processed by an e-mail server before it can be routed to the receiving computer.

Another typical aspect of computer networks used by many companies is the shared usage of printers. Ideally, each computer on the network has a stand-alone printer located close by, whereby all print jobs from the computer go directly to the stand-alone printer. Due to cost constraints, and also to deal with situations in which a stand-alone printer malfunctions, there is a need to send print jobs to any of a plurality of network printers that are capable of receiving print jobs from one or more computers on the network.

When a print job is received by a network printer, the user who sent the print job typically waits a short period of time for the print job to finish. After the short time period has elapsed, then the user walks over to the network printer that was given the print job, so that the user can retrieve the completed print job and take it back to his or her desk to review.

However, when there is a malfunction at the network printer, or when another print job that was sent by a second user on the network prior to the user's print job is still printing at the network printer, there is a problem in that the user may have wasted valuable time walking over to pick up the print job at the network printer before it is completed. This forces the user to either walk back to his or her desk and come back to the printer at a later time, or just wait at the printer for the print out to be completed.

To deal with such unwelcome situations, there currently exist redundant network print systems, such as a printer server manufactured by Dazel, Inc., which are configured to send a print job to another printer when a printer for which a print job has been sent is for some reason not currently capable of performing the print job. The user is informed of a switch of the print job to the other printer (by e-mail or by web page notification), and thus the user is notified to walk over to the location of the other printer in order to pick up his or her print job when it is completed.

The Dazel printer server corresponds to an external piece of hardware added to the network, whereby all print requests are received by the Dazel printer server, which determines whether or not any of those requests are to be redirected to another printer. To perform this function, the Dazel printer server periodically obtains a status of each of the printers on the network, to determine if any of those printers are currently available to handle a print request, and if so, to redirect a print job under control of the Dazel printer server.

Furthermore, the Dazel system requires its own Internet Protocol (IP) address so it can forward all print requests made to any printer on the network as output by any computer on the network.

There is a need to provide a network printer system that is capable of routing a print job from a printer that is currently incapable of handling the print job, to another printer that is capable of handling the print job, without the need to have an extra external piece of hardware loaded onto the network, and without the need to add another IP address to the network.

### SUMMARY OF THE INVENTION

According to one aspect of the invention, there is provided a printer system, which includes a first printer that is capable of being in one of a ready state and a not ready state, with respect to processing any incoming print jobs. The print system also includes a second printer that is capable of being in one of the ready state and the not ready state. The first printer redirects a print job sent to the first printer, to the second printer, when the first printer is in the not ready state.

In a further aspect of the invention, there is provided a printer administrator that is coupled to the first printer and the second printer by way of a communications network, in which the printer administrator is notified by the first printer as to any print redirections made by the first printer.

According to another aspect of the invention, there is provided a printer system, which includes a first printer that is capable of being in one of a ready state and a not ready state, with respect to processing any incoming print jobs, wherein the not ready state includes at least a first non-recoverable error sub-state. The printer system also includes a second printer. The first printer redirects a print job sent to the first printer, to the second printer, when the first printer is in the first non-recoverable error sub-state.

In a further aspect of the invention, there is provided a third printer, in which the first printer redirects a print job sent to the first printer, to the third printer, when the first printer is in a second non-recoverable error state.

According to yet another aspect of the invention, there is provided a printer system, which includes a first printer having a first set of printing capabilities. The printer system also includes a second printer having a second set of printing capabilities greater than the first set of printing capabilities. The first printer includes a processor for reading information contained in a print job sent to the first printer. The first printer redirects the print job to the second printer when the information contained in the print job is such that the capabilities of the first printer will not allow it to properly perform the print job while the capabilities of the second printer will allow it to properly perform the print job.

According to still another aspect of the invention, there is provided a method of printing a job on one of a plurality of network printers coupled to a network. The method includes receiving, by a first of the network printers, a print job. The method also includes determining, by the first of the network printers, a current operating state of the first of the network printers, the current operating state being either a first state or a second state. The method further includes routing, by the first of the network printers, the print job to a second of the network printers when the operating state is in the first state.

According to still another aspect of the invention, there is provided a method of printing a job on one of a plurality of network printers coupled to a network. The method includes receiving, by a first of the network printers, a print job. The method also includes determining, by the first of the network printers, a current operating state of the first of the network printers, the current operating state including at least one state corresponding to a non-recoverable error state. The method further includes routing, by the first of the network printers, the print job to a second of the network printers when the operating state is the non-recoverable error state.

According to still yet another aspect of the invention, there is provided a method of printing a job on one of a plurality of network printers coupled to a network. The method includes receiving, by a first of the network printers, a print job. The method also includes reading, by the first of the network printers, at least a portion of information contained in the print job. The method further includes determining, by the first of the network printers, whether or not the first of the network printers is capable of performing the print job based on the information contained in the print job. The method still further includes either routing the print job to another of the network printers or executing the print job by the first of the network printers, based on a result of the determining step.

### BRIEF DESCRIPTION OF THE DRAWINGS

The embodiments of the present invention will become more fully apparent from the following detailed description when read in conjunction with the accompanying drawings with like reference numerals indicating corresponding parts throughout, wherein:

FIG. 1 is a diagram showing a personal computer, a network printer in a Not Ready state, and a buddy printer, in accordance with a first or second embodiment of the invention;

FIG. 2 is a flow diagram showing various steps performed by a processor of a first contact printer, according to the first embodiment of the invention;

FIG. 3 is a diagram showing a personal computer, a network printer in a non-recoverable error state, and a buddy printer, in accordance with a third or fourth embodiment of the invention;

FIG. 4 is a flow diagram showing various steps performed by a processor of a first contact printer, according to the third embodiment of the invention;

FIG. 5 is a diagram showing a personal computer, a network printer that does not have sufficient resources to perform a print job, and a buddy printer, in accordance with a fifth or sixth embodiment of the invention;

FIG. 6 is a flow diagram showing various steps performed by a processor of a first contact printer, according to the fifth embodiment of the invention;

FIG. 7 is a block diagram showing various elements making up a network printer of any of the first through sixth embodiments of the invention;

FIG. 8 is a diagram showing a printer web page, whereby information on the printer and print jobs sent to the printer can be obtained; and

FIG. 9 is a diagram showing a printer web page, whereby printer network information such as printer Internet Address and printer Internet Hostname may be obtained.

### DETAILED DESCRIPTION OF THE PREFERRED EMBODIMENTS

Preferred embodiments of the invention will be explained below with reference to the accompanying drawings.

The present invention relates to a network print system that automatically redirects print jobs from a first printer on the network to a second printer on the network, under control of the first printer.

Typically, when a user on a personal computer (PC) connected to the network has a print job to be printed, the user selects a network printer to perform the print job. Alternatively, a network printer may have been previously selected to perform the print job (and all other print jobs) output by the user. The assigned network printer is typically located close to the user's computer, so that the user does not have to walk far from his or her desk in order to retrieve the print job after it has been completed.

Ideally, the assigned network printer is highly reliable, so that the user does not have to utilize other printers to handle the print job due to a malfunction or other problem with the assigned network printer. For conventional print systems, in the event of a problem at the assigned network printer, the user typically has to physically go over to the assigned network printer, ascertain that there is a problem (e.g., paper jam) with the network printer, and then have to either fix the problem, or more likely go back to the user's computer to reassign the print job to another printer on the network.

Alternatively, the user would be informed of the problem at his or her computer (e.g., e-mail notification), and then would have to choose another network printer to perform the print job that is preferably located close by. The user would then have to reassign the print job at the user's computer to the other closely-located network printer.

When a first user sends a print job to the assigned network printer, the first user typically waits some amount of time (e.g., from a few seconds up to several minutes or more) before walking over to retrieve the print out. This allows for the time the network printer takes to complete the print job. However, if the network printer is malfunctioning or if a second user on the network has sent a print job that is currently being printed at the same network printer (and thus the print job output by the first user is queued up at the network printer), then the first user may have wasted valuable time in walking over to retrieve the print job, whereby the print job of the first user is not ready to be picked up yet.

This problem is exacerbated in the case when a user goes over to retrieve his or her print job, realizes that it is not ready due to a malfunction (e.g., paper jam) at the assigned network printer, and whereby the user also realizes that another printer located close by is in an idle state and could have accepted and finished the print job if the print job would have been sent to the other printer instead.

In that case, the user has to walk back to his or her computer, reassign the print job to the other network printer, and then walk back to retrieve the print job from the other network printer after it has completed the job. Needless to say, this is a very frustrating process and may cause deterioration in one's mental state and work performance that may last for several hours after the printing incident has occurred.

The present invention overcomes this problem by redirecting network print jobs when it is deemed proper to do so. Such times for redirection may be: 1) when a network printer is in a “not ready to process print jobs” (or “not ready”) state, or 2) when a network printer is experiencing a nonrecoverable error and is not capable of starting any print jobs (or finishing an existing print job already started) until the error is fixed, or 3) when a network printer is operating normally and printing an existing print job, and where any new print jobs to the same network printer would have to go into a print queue to be printed after the current job or jobs are completed, or 4) when a network printer does not have sufficient resources for performing all of the requirements set forth in a print job.

In the present invention, the redirection of print jobs is made by the printers themselves, without any print server or printer administrator being utilized in the redirection of a print job from one printer to another printer. In a preferred implementation of the present invention, the print server or printer administrator is informed of the redirection made by a printer. With information obtained for all redirections made over a network, a network administrator can make decisions as to any future network changes (e.g., change a printer assigned to a user to a printer capable of more memory storage or an enhanced printer font capability). The printer administrator may be either a person who makes decisions based on information provided to him or her, or it may be a separate (software-enabled) system that makes print decisions based on metrics, whereby print decisions are automatically made without human intervention.

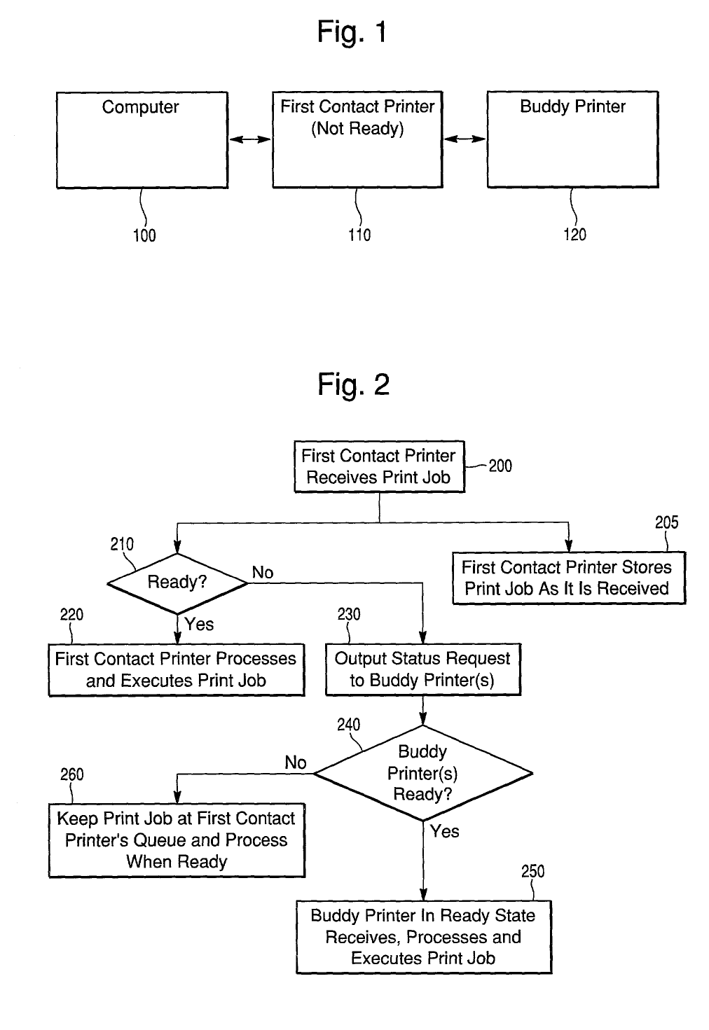

A first embodiment of the invention will be described below with reference to FIG. 1. The present invention is directed to printers or to multi-function printers (MFPs), which may also provide digital scanning functions, stapling functions, and/or collating functions and copying functions.

A printer/MFP operates in one of two possible machine states. One state is “Ready”, and the other state is “Not Ready”. These states correspond to whether or not the printer/MFP is currently capable of processing any new print jobs sent to it.

The “Not Ready” state can be subdivided into such sub-states, for example, as “Processing Job”, “Front Door Open”, “Clear Paper Jam”, “Memory Full”, etc.

If the Printer/MFP is “Not Ready”, then any new, incoming print job cannot be processed by the Printer/MFP until the printer/MFP enters the Ready state. The present invention provides for a printer/MFP in the Not Ready state to automatically redirect to another printer any new, incoming print job that it receives over the network.

The redirection can be performed in any of the ways described below. In a first redirection procedure, all new, incoming jobs are redirected to one of a selected list of other “Ready” printer/MFPs on the network. In a second redirection procedure, all new, incoming jobs are redirected to a particular printer/MFP on the network based on a specific “Not Ready” sub-state of the printer/MFP that initially receives the print job. For example, in one implementation, for the “Processing Job” Not Ready sub-state whereby one or more print jobs are ahead of the incoming print job, the incoming print job will be kept with the initially assigned printer, since that printer will be available to handle the print job after it completes its current print job. However, for a “Clear Paper Jam” Not Ready sub-state, whereby human intervention is required to get the printer back to the Ready state, the incoming print job will be redirected to another printer that is in the Ready state (since it may take a while to get a technician to come to the printer to fix this error). Of course, the system can be programmed so that even incoming print jobs when the printer is in the “Processing Job” sub-state are redirected to an available buddy printer.

The information on the state of the other printers on the network, as well as their IP addresses, is retrieved by the printer/MFP that initially receives the print job. Printers on the network are capable of determining the status of other printers on the network, by way of printer machine language (PML) objects or printer job language (PJL) objects (or other types of printer communication protocols), which are low level queries between print drivers. Using PML objects or PJL objects, any printer can determine the status of any other printer on the network. Using the status information, a first printer determines a “buddy” printer to redirect a print job to, when the first printer is in the “Not Ready” state.

In the present invention, the second printer that receives the redirected print job is referred to as the “buddy” printer. The determination of which printers to assign to other printers as their buddies may be performed by the printer administrator on the network, based on locations of printers (buddy printers being located close to each other), types of printers (all printers of the same type on the network, such as all LaserJet 4000s on the network, are assigned as buddies to each others), etc.

When a print job is redirected by a printer to its buddy printer, the user is notified as to this redirection, so that the user will be informed to go to the location of the redirected printer (instead of the location of the initially assigned printer) in order to retrieve the printout. The notification may be by an e-mail notification to the user's computer, as initiated by the printer that redirected the print job (or by a printer administrator that is notified of the redirection), and/or by a display front panel on the printer that was initially assigned the print job (and that redirected the print job), and/or by an embedded web page service page notification.

For the embedded web page service page notification, each printer on the network is assigned its own web page (and corresponding web page address), which is accessible by a user on his/her personal computer by the user accessing a web browser (e.g., Netscape Navigator/Communicator or Microsoft Explorer browsers) and navigating to the appropriate web page for a printer that was sent a print job. That way, the user can determine the status of a print job in real time.

As shown in FIG. 1, a user, by way of his or her computer 100, sends a print job to a first contact printer 110, which is typically the default printer assigned to handle print jobs output by the user's computer 100. The print job is stored at the first contact printer 110, such as in a hard drive of the first contact printer 110 or in some other storage medium at the first contact printer 110.

When the first contact printer 110 is in a Not Ready state to process any new incoming jobs, it redirects the print job to a buddy printer that is in the Ready state, such as the second contact printer 120 shown in FIG. 1. Upon this redirecting, an e-mail may be sent back to the user and/or the printer administrator (not shown in FIG. 1), as output by the first contact printer 110, notifying them that a print redirection has occurred. Alternatively, the user can check a web page of the first contact printer 110 to determine the status of the print job. At that web page, the user will find out that the print job has been redirected, as well as being informed as to the buddy printer 120 that received the redirected print job.

The assignment of a buddy printer or buddy printers in the first embodiment may be made based on location (all buddies being located close to each other), or based on type of printer (all printers of a same type are buddies to each other), or another criteria, or based on a combination of these or different criteria.

FIG. 2 is a flow chart showing the various steps performed by the first contact printer 110, according to the first embodiment of the invention. In step 200, the first contact printer 110 receives a print job output from the computer 100. In step 205, the print job is stored by the first contact printer 110 as the job is received. This storage may be performed by way of memory in the first contact printer 110, or by use of another storage device, such as an available file server on the network.

In step 210, at substantially the same time that the print job is being stored by the first contact printer 110, the first contact printer 110 checks its own status to determine if it is in the Ready state or the Not Ready state. If the first contact printer 110 is in the Ready state, then the print job is started by the first contact printer 110, as shown in step 220. If the first contact printer 110 is in the Not Ready state, then the first contact printer 110 determines if any of its buddy printers can take the print job.

This determination is made by the first contact printer 110 requesting a current status of one or more of its buddy printers, as shown in step 230. If there is a buddy printer is in the Ready state, as determined in step 240, then the first contact printer 110 redirects the print job to the buddy printer 120, as shown in step 250. This redirection involves sending to the buddy printer 120 the print job that was stored by the first contact printer 110 (in step 205), and may include the steps of notifying the buddy printer 120 as to the location (e.g., file server IP address) of where the print job can be retrieved.

If none of the buddy printers of the first contact printer 110 is in the Ready state as determined in step 240, then the print job is not redirected by the first contact printer 110, and instead is placed in the print queue of the first contact printer 110 for execution of the print job as soon as the first contact printer 110 goes into the Ready state, as shown in step 260.

In a second embodiment of the invention, the first contact printer 110 has only one buddy printer, and does not first obtain the status of its buddy printer before it redirects a print job to its buddy printer. Rather, when the first contact printer 110 is in the Not Ready state, it automatically redirects the print job to its buddy printer 120. Upon receipt of the print job, the buddy printer 120 determines its state, and either performs the print job if it is in the Ready state, or redirects the print job to its buddy printer. In this second embodiment, care must be taken so that two printers are not assigned as buddies to each other. That way, there is a better chance that at least one printer in a network of printers is in the Ready state, to thereby available to execute the print job.

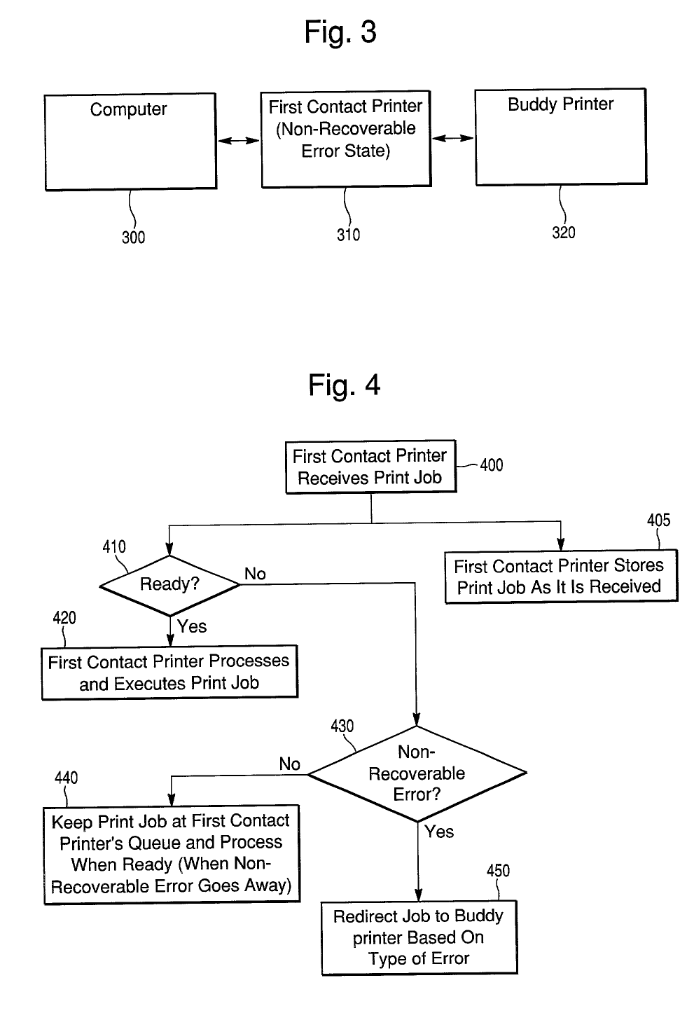

A third embodiment of the invention will be described below with reference to FIG. 3, whereby a print job output by a computer 300 is redirected by a first contact printer 310 to a second printer or buddy printer 320, when the first contact printer 310 is currently in a non-recoverable error state. A printer, or multi-function printer (MFP), may fail to complete a current, in-progress print job due to a number of reasons. For example, one reason may be that the page is too complex (e.g., LaserJets typically print the page as the page is being rendered. This is known as “racing the laser”. The print job needs to be rendered, or converted, into bits (e.g., 1's and 0's) by a graphics engine of the printer, quicker than the laser beam's need for data bits for printing a particular portion or strip of a page to be printed. If the LaserJet starts printing a page, and cannot render the remaining page portions before the laser beam sweep is in position to print the bits, then the LaserJet “punts” the incomplete page and generates a “Page Too Complex Error). Another reason may be that the network printer assigned to handle the print job is out of available memory for the page to be printed, resulting in a “memory out” error.

In the third embodiment, once the printer/MFP detects that it is in a non-recoverable error state, the print job is redirected to another printer/MFP, in an attempt to complete the print job. To do this, the printer/MFP stores the job stream upon receipt of the print job from the sending computer, in the event that it has to redirect the print job to another network printer.

The storing of the job stream may be done entirely at the printer/MFP, or, if it does not have sufficient memory capability due to the size of the print job, the print job may be stored at another memory location on the network, such as an available file server on the network.

The network printer assigned to perform the print job tries to accomplish its task. However, if the print job cannot be performed due to a non-recoverable error at the printer (which may occur before the print job was sent to the printer, or during the printing of the print job), such as the ones described above, the printer/MFP according to the second embodiment redirects the print job to a “buddy” printer/MFP, so that the print job can be processed by the buddy printer/MFP.

When the print job is redirected, the data file to be printed is also sent to the buddy printer, and/or the location of the data file (e.g., IP address of a network file server that is storing the print job) is provided to the buddy printer, so that the buddy printer will know where to go to retrieve the print job.

As shown in FIG. 3, the user sends a print job, by way of computer 300, to the first contact printer 310. If the first contact printer 310 is currently in a non-recoverable error state, or if it gets into that state during execution of the print job, then the entire print job is redirected to the buddy printer 320.

A printer may have more than one “buddy” printer assigned to it, whereby one of the buddy printers that is currently capable of handling the print request (that cannot be handled by the printer) is assigned the print job. That way, if a first buddy is not currently capable of handling the print job, the printer may assign the print job to a second buddy currently capable of handling the print job.

In a first configuration of the third embodiment, a first buddy printer is assigned by the first contact printer 310 to perform the redirected print job when the first contact printer 310 experiences a first type of non-recoverable error, such as a Memory Full error. A second buddy printer is assigned by the first contact printer to perform the redirected print job when the first contact printer 310 experiences a second type of non-recoverable error, such as a Page Too Complex error.

The determination of which buddy printer of a group of buddy printers of the first contact printer 310 to assign a print job to, is based on the resources of the buddy printers. These assignments are preferably done by the printer administrator, which knows the capabilities of each of the network printers on the network. Thus, if the first contact printer 310 experiences a Memory Full error that may be due to a print job being too large in size for the first contact printer 310, then the print job is automatically reassigned by the first contact printer 310 to a first buddy printer that has a larger memory capability than the first contact printer 310.

Also, if the first contact printer 310 experiences a Page Too Complex error that may be due to the a print job requiring greater processing performance not available by the first contact printer 310, then the print job is automatically reassigned by the first contact printer 310 to a second buddy printer that has greater processing power and can “race the laser” by rendering the page into bits before the laser beam sweep requires the bits. While it is possible that the second buddy printer may not be capable of performing the print job, at least it has a better chance of doing so.

The user is informed of any redirection of a print job that the user sends out over the network. That way, the user will be informed to go the correct physical location where the buddy printer 320 is disposed, as opposed to a location where the first contact printer 310 (which redirected the print job) is disposed. The notification may be done by sending an e-mail back to the user's computer 300, as output by the first contact printer 310, to inform the user of the print job redirection. The printer administrator (not shown), which keeps track of all print jobs on the network, and which preferably runs on a dedicated computer on the network, may also be informed by the first contact printer 310 of the print job redirection.

Additionally or alternatively to the e-mail notification, a user can check a web page on an Intranet or on the Internet, which includes information concerning the print job output by the user and whether or not it has been redirected (and if so, where it can been redirected). The web page information is updated by the first contact printer 310 providing the print job redirection information to the printer administrator, which is responsible for maintaining the print job web page on the Intranet or on the Internet. When the printer administrator is notified of the print job redirection, it updates information concerning the print job on the web page, so that the user can keep track of the status of the print job, as well as which printer is handling the print job.

FIG. 4 is a flow chart showing the various steps performed by the first contact printer 310, according to the third embodiment of the invention. In step 400, the first contact printer 310 receives a print job from the computer 310. In step 405, the print job is stored by the first contact printer 310 as it is received from the computer 300. This storage may be done by way of memory of the first contact printer 310, or by use of another storage device, such as an available file server on the network, or by a combination of both. For example, as the print job is being stored at the first contact printer 310, the size of the print job may be such that it will exceed the memory storage capability of the first contact printer 310. In that case, the first contact printer 310 keeps track of the amount of memory space being taken up by storing the incoming print job, whereby if the memory space is about to be exceeded, the remaining part of the print job is redirected to another memory storage, such as an available file server on the network.

In step 410, at the same time that the print job is being stored by the first contact printer 310, the first contact printer checks 310 its own status to determine if it is in the Ready state or the Not Ready state. If the first contact printer 310 is in the Ready state, then the print job is started by the first contact printer 310, as shown in step 420. If the first contact printer 310 is in the Not Ready state, then the first contact printer 310 determines whether or not the Not Ready state is due to a recoverable error or a non-recoverable error, as shown in step 430. If the first contact printer 310 is experiencing a recoverable error (e.g., front door open, out of paper), then the first contact printer 310 does not redirect the print job but instead waits until the recoverable error is fixed, at which time it can process the print job, as shown in step 440.

If the first contact printer 310 is experiencing a non-recoverable error (e.g., Memory Full, Page Too Complex), then the first contact printer 310 redirects the print job to an assigned buddy printer 320, where the assignment is made based on the type of non-recoverable error, as shown in step 450. The print job, stored in step 405, is sent to the buddy printer 320 if a redirection occurs.

In a fourth embodiment of the invention which incorporates features of the first and third embodiments, the first contact printer 310 does not automatically redirect a print job to a buddy printer when the first contact printer 310 experiences a non-recoverable error, but rather the first contact printer 310 checks the current status of its buddy printers, and whereby the first contact printer 310 only redirects a print job to a buddy printer when the first contact printer 310 is in a non-recoverable error state and at the same time the first contact printer 310 has determined that the buddy printer to be given the print job is in a Ready state. As explained above, the current status of other network printers can readily be obtained by low-level queries sent over the network to other printers by the first contact printer 310.

In the fourth embodiment, if none of the buddy printers is in the Ready state, then the print job is not performed by any of the network printers, remains in the queue, and the user is notified.

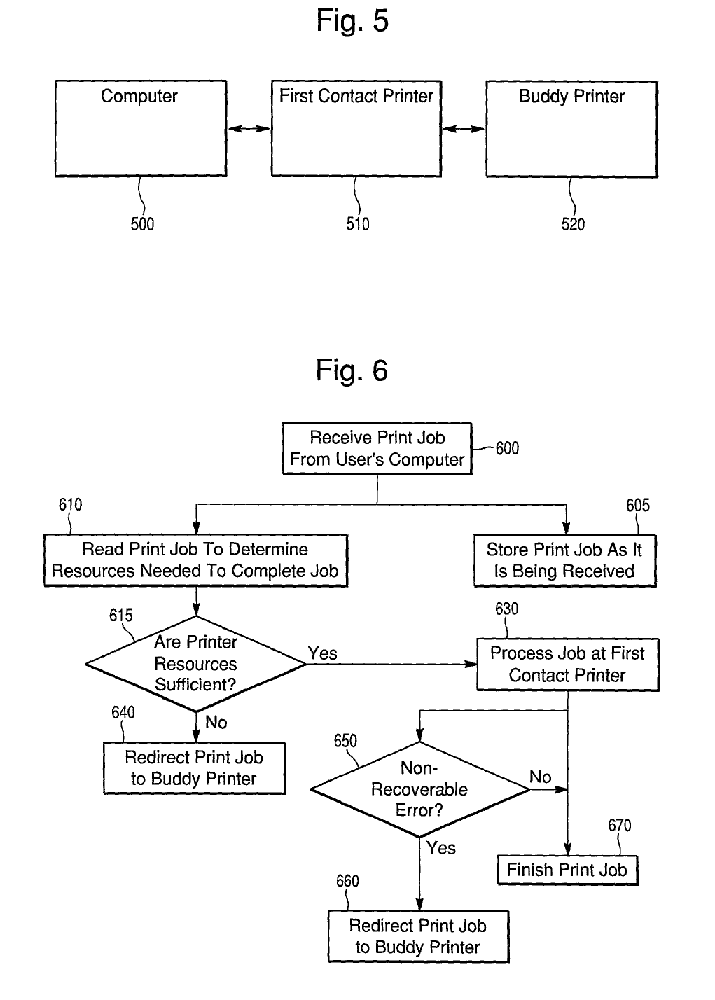

A fifth embodiment of the invention will be described below, with reference to FIG. 5. In the fifth embodiment, when a print job output by a user's computer 500 is received by a first contact printer 510 on the network, the print job is saved to hard disk at the first contact printer (e.g., a random access memory of the printer), or is saved to an available storage medium (e.g., file server) on the network, which is accessible by any network printer. At the same time that the print job is being saved by the first contact printer 510, the print job is being read by a processor of the first contact printer 510. In the fifth embodiment, the first contact printer 510 reads a portion of the print job to determine if it is capable of executing the print job, and if it is not capable, the print job is sent to a buddy printer 520 that is capable of executing the print job.

The steps performed by a processor of a network printer according to the fifth embodiment of the invention will be described below with reference to the flow chart of FIG. 6.

In step 600, the first contact printer 510 receives a print job from the user's computer 500 by way of a network connection. In step 605, the print job is stored as it is being received by the first contact printer 510. In step 610, which occurs concurrently with step 605, the processor of the first contact printer 510 reads at least a header portion of the print job, and in step 615 it determines if the printer has sufficient capabilities or resources to perform the job. The print job is typically written with a printer job language (PJL) wrapping some other type of page description language that is readable by print drivers. The processor of the first contact printer 510, typically a reduced instruction set (RISC) processor or the like, reads and parses the print job that it receives, and then determines if the first contact printer 510 is capable of handling the print job.

If the processor of the first contact printer 510 determines that the first contact printer 510 is capable of handling the print job, then it processes the print job in step 630. If the processor of the first contact printer 510 determines that the first contact printer 510 is not capable of handling the print job, then the print job is redirected to the buddy printer 520 that does have sufficient resources to handle the print job, in step 640.

The following steps incorporate features of the third embodiment, and are optional steps of one possible implementation of the fourth embodiment described above. While the first contact printer 510 is processing (and printing) the print job in step 630, if a non-recoverable error occurs at the first contact printer 510, as in step 650, then the print job is redirected to the buddy printer 520, as in step 660. If the first contact printer 510 does not experience a non-recoverable error while it is processing and printing the print job, then the print job is completed by the first contact printer 510 without redirecting it to any other printer, as in step 670.

A sixth embodiment incorporates features of the first and fifth embodiments. In the sixth embodiment, a print job is only redirected by the first contact printer if the buddy printer is in a Ready state. Thus, before any print job is redirected, the first contact printer obtains current status information from its buddy printers, to determine if a print job that it cannot handle can be redirected to any of them.

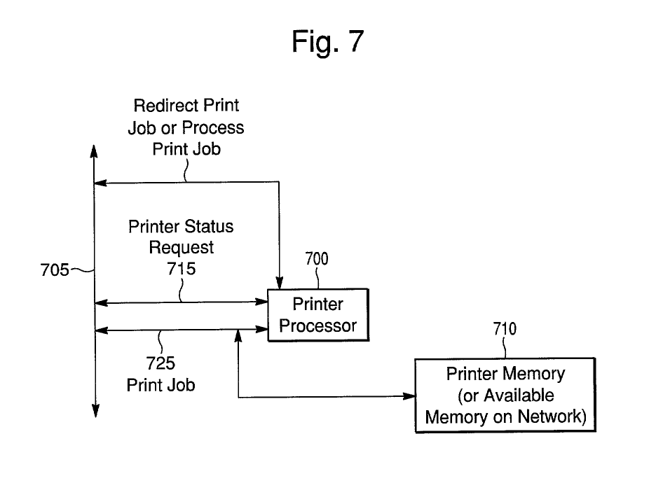

FIG. 7 shows a processor 700 and a memory 710 of a network printer according to any of the first through sixth embodiments of the invention. The processor 700 receives the print job over the network 705 as output by a user's computer (not shown), and determines the current state of the printer, but it can be a storage medium on the network separate from the printer. At the same time, the print job is stored in the memory 710 while being received by the printer. The memory 710 is preferably a hard drive of the printer. Based on the current state of the printer, the print job is either processed by the printer, or redirected to another printer.

In the first embodiment, the processor 700 outputs requests to other buddy printers to determine their current status, which it sends out over the network 705 (as shown by line 715) when the printer is in a not ready state and has received a print job (as shown by line 725). Also, in the fifth and sixth embodiments, the processor 700 reads information in the print job, to determine if the printer is capable of handling the print job (e.g., if the job is a duplex printing job, then does the printer have this capability). If the printer is not capable of handling the print job, as determined by the processor 700 in the fifth and sixth embodiments, then the print job is redirected to another printer that is capable of handling the print job (only if the other printer is in the Ready state, in the sixth embodiment). Information as to capabilities of other printers may be stored in the memory 710.

For example, in the fifth embodiment, a print job may require that it is be printed in duplex format, or that the print job be stapled, or that the print job be done in color. The print job may also require that it be printed in a particular language (e.g., Chinese character set), or with a particular set of fonts. If the printer is not capable of performing the print job based on the requirements as set forth in the print job, then the print job is redirected.

To perform the redirection, the printer/MFP spools the print job off its hard disk, and redirects the print job to the buddy printer. If the print job was stored in a file server or other storage location on the network, then the printer/MFP informs the printer that received the redirected print job as to the location (e.g., IP address) of the storage medium that is storing the print job to be printed.

A printer can have multiple buddies, whereby a print job is redirected to a particular buddy based on the requirements of a print job. For example, if a first printer does not have stapling capabilities and does not have duplex printing capabilities, then the printer should have assigned to it a first buddy printer that has stapling capabilities and a second buddy printer that has duplex printing capabilities. When a print job to-be-stapled is received by the printer, then it automatically redirects the print job to the first buddy printer. When a print job to-be-duplex-printed is received by the printer, then it automatically sends the print job to the second buddy printer.

In the sixth embodiment, if a print job is to be redirected by a first contact printer but whereby no buddy printer is in the Ready state, then the first contact printer may attempt to complete the print job to the best that it can, based on its capabilities, or it can notify the user to thereby allow the user to choose whether or not the user wants the first contact printer to complete the job to the best of its ability (e.g., print but not staple), or wait until an available buddy printer that can completely accomplish the print job is ready to do so. This notification can be made via an e-mail sent to the user, for example.

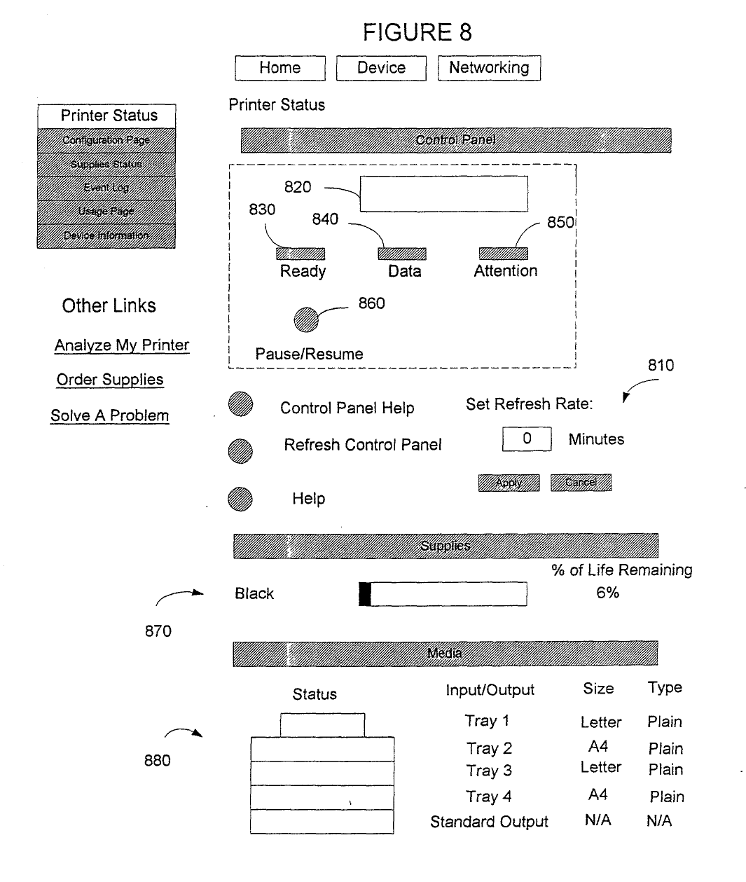

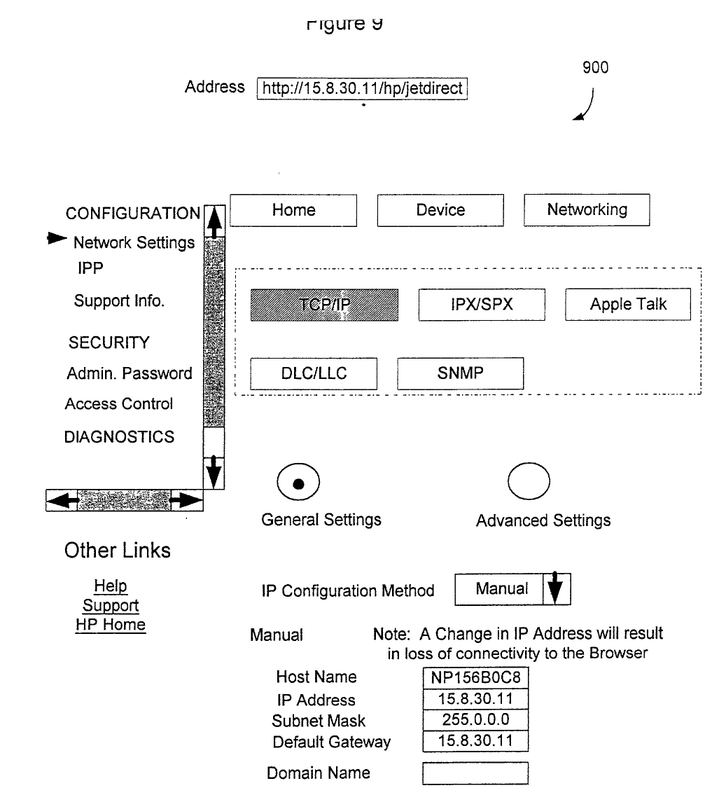

FIG. 8 is a diagram showing printer information obtained from a “Printer Status” web page of a network printer according to any of the embodiments of the invention. The Printer Status web page is a sub-web page that is accessed from a main web page of the network printer. For example, a web address such as www.jimmysprinter.hp.com (or http://15.8.30.11/hp/jetdirect, as shown in FIG. 9) may be a web page address for a printer on a network. The Printer Status web page includes a “Control Panel” region 810 that provides information with respect to print jobs sent to the printer, as well as any print jobs redirected to other printers by the printer. For example, “Print Job 401 Redirected to Printer #4” may be shown on the “Control Panel” region 810 to indicate a print job that has been redirected to another printer.

The “Control Panel” region 810 includes a Status panel 820, a “Ready” indication 830, a “Data” indication 840, and an “Attention” indication 850. Also provided on the Control Panel region 810 is a “Pause/Resume” control 860. Also shown on the web page is a “Supplies” region 870 (indicating, among other things, a remaining life of an ink cartridge disposed on the printer), and a “Media” region 880. The “Media” region 880 provides information on the paper trays that are currently disposed on the network printer.

FIG. 9 is a diagram showing “Networking” information 900 obtained from another web page of the network printer according to any of the embodiments of the invention. This web page is accessed from the home web page of the network printer by the user clicking on the “Networking” button on the home web page. On the “General Setting” option, the user can find information related to a Host Name, an IP Address, a Subnet Mask, a Default Gateway, among others. Though not shown in FIG. 9, a user can assign one or more buddy printers for any print jobs that the user sends to the printer, by way of the “Advanced Settings” option on the printer web page shown in FIG. 9.

While preferred embodiments have been described herein, modification of the described embodiments may become apparent to those of ordinary skill in the art, following the teachings of the invention, without departing from the spirit and scope of the invention as set forth in the appended claims.

What is claimed is:

1. A printer system, comprising:
a first printer that is capable of being in one of a ready state and a not ready state, with respect to processing any incoming print jobs;
a second printer that is capable of being in one of the ready state and the not ready state,
wherein the first printer redirects a print job sent to the first printer, to the second printer, when the first printer is in the not ready state.

2. The printer system according to claim 1, further comprising:
a printer administrator that is coupled to the first printer and the second printer by way of a communications network,
wherein the printer administrator is notified by the first printer as to any print job redirections made by the first printer.

3. A printer system, comprising:
a first printer that is capable of being in one of a ready state and a not ready state, with respect to processing any incoming print jobs, wherein the not ready state includes at least a first non-recoverable error sub-state;
a second printer,
wherein the first printer redirects a print job sent to the first printer, to the second printer, when the first printer is in the first non-recoverable error sub-state.

4. The print system according to claim 3, further comprising:
a third printer,
wherein the not ready state also includes a second non-recoverable error sub-state, and
wherein the first printer redirects a print job sent to the first printer, to the third printer, when the first printer is in the second non-recoverable error sub-state.

5. The printer system according to claim 3, further comprising:
a printer administrator that is coupled to the first printer and the second printer by way of a communications network,
wherein the printer administrator is notified by the first printer as to any print job redirections made by the first printer.

6. A printer system, comprising:
a first printer having a first set of printing capabilities; and
a second printer having a second set of printing capabilities greater than the first set of printing capabilities,
wherein the first printer includes a processor for reading information contained in a print job sent to the first printer, and
wherein the first printer redirects the print job to the second printer when the information contained in the print job is such that the capabilities of the first printer will not allow it to properly perform the print job while the capabilities of the second printer will allow it to properly perform the print job.

7. The printer system according to claim 6, further comprising:
a printer administrator that is coupled to the first printer and the second printer by way of a communications network,
wherein the printer administrator is notified by the first printer as to any print job redirections made by the first printer.

8. A redundant printer system, comprising:
a first printer that receives print jobs over a network;
a second printer that receives print jobs over the network,
wherein the first printer redirects a print job sent to the first printer, the redirection being made to the second printer, when the first printer is not capable of printing the print job.

9. A method of printing a job on one of a plurality of network printers coupled to a network, comprising:
receiving, by a first of the network printers, a print job;
determining, by the first of the network printers, a current operating state of the first of the network printers, the current operating state being either a first state or a second state; and
routing, by the first of the network printers, the print job to a second of the network printers when the operating state is in the first state.

10. The method according to claim 9, further comprising:
executing the print job, by the first of the network printers, when the operating state of the first of the network printers is in the second state,
wherein the print job is not routed to the second of the network printers when the operating state of the first of the network printers is in the second state.

11. The method according to claim 10, wherein the first state is a Not Ready to Process Incoming Print Jobs state, and
wherein the second state is a Ready to Process Incoming Print Jobs state.

12. A method of printing a job on one of a plurality of network printers coupled to a network, comprising:
receiving, by a first of the network printers, a print job;
determining, by the first of the network printers, a current operating state of the first of the network printers, the current operating state including at least one state corresponding to a non-recoverable error state; and
routing, by the first of the network printers, the print job to a second of the network printers when the operating state is the non-recoverable error state.

13. The method according to claim 12, further comprising:
executing the print job, by the first of the network printers, when the operating state of the first of the network printers is in a state other than the non-recoverable error state,
wherein the print job is not routed to the second of the network printers when the operating state of the first of the network printers is in the state other than the non-recoverable error state.

14. A method of printing a job on one of a plurality of network printers coupled to a network, comprising:
receiving, by a first of the network printers, a print job;
reading, by the first of the network printers, at least a portion of information contained in the print job;
determining, by the first of the network printers, whether or not the first of the network printers is capable of performing the print job based on the information contained in the print job; and either routing the print job to another of the network printers or executing the print job by the first of the network printers, based on a result of the determining step.
